(19) United States
(12) Patent Application Publication
(10) Pub. No.: US 2023/0164381 A1
(43) Pub. Date: May 25, 2023

(54) BULLET-SCREEN COMMENT PRESENTATION AND SENDING METHODS AND APPARATUSES IN CO-HOSTING DURING LIVE STREAMING

(71) Applicant: SHANGHAI BILIBILI TECHNOLOGY CO., LTD., Shanghai (CN)

(72) Inventor: Jiawei FU, Shanghai (CN)

(21) Appl. No.: 17/992,355

(22) Filed: Nov. 22, 2022

(30) Foreign Application Priority Data
Nov. 25, 2021 (CN) 202111413864.2

(51) Int. Cl. H04N 21/431; H04N 21/2187; H04N 21/442

(52) U.S. Cl. CPC H04N 21/4314; H04N 21/2187; H04N 21/442

(57) ABSTRACT

This application discloses techniques of presenting bullet screens during co-hosted live streaming. The techniques comprise monitoring whether there is a co-hosting success instruction; enabling a split screen mode in response to receiving the co-hosting success instruction, the split screen mode configured to implement simultaneous display of a first area and a second area on a screen, the first area associated with the first host, and the second area associated with the second host; receiving first bullet screen data comprising comments on a first live streaming video associated with the first host, and receiving second bullet screen data comprising comments on a second live streaming video associated with the second host; and presenting the comments on the first live streaming video in the first area, and presenting the comments on the second live streaming video in the second area.

### CROSS-REFERENCE TO RELATED APPLICATIONS

This application claims priority to Chinese Patent Application No. 202111413864.2, filed on Nov. 25, 2021, and entitled “BULLET-SCREEN COMMENT PRESENTATION AND SENDING METHODS AND APPARATUSES IN CO-HOSTING DURING LIVE STREAMING”, which is incorporated herein by reference in its entirety.

### BACKGROUND

Users may attempt to access conventional social media on their devices to communicate about interesting content. Using conventional social media may be cumbersome as users may have to switch back and forth between different applications to access the content of interest and social media related to the content. As communication devices, such as mobile phones, become more sophisticated, people continue to discover new ways to communicate.

### SUMMARY

In view of this, bullet-screen comment presentation and sending methods and apparatuses in co-hosting during live streaming, a computer device, and a computer-readable storage medium are provided, so as to resolve a problem of insufficient interaction between the users and poor user experience in an existing co-hosting process during live streaming due to a fact that live streaming users of both hosts cannot directly interact with each other.

This application provides a bullet-screen comment presentation method in co-hosting during live streaming, applied to a terminal device, including:

enabling a split screen mode in response to a co-hosting success instruction for a first host and a second host, where the split screen mode means displaying a first area and a second area on a screen, the first area is associated with the first host, and the second area is associated with the second host;

receiving first bullet-screen comment information associated with the first host, and receiving second bullet-screen comment information associated with the second host; and

presenting the first bullet-screen comment information in the first area, and presenting the second bullet-screen comment information in the second area.

Optionally, the receiving first bullet-screen comment information associated with the first host, and receiving second bullet-screen comment information associated with the second host includes:

receiving, through a first communication link, the first bullet-screen comment information associated with the first host, and receiving, through a second communication link, the second bullet-screen comment information associated with the second host.

Optionally, the method further includes:

receiving, through the first communication link, a first live streaming video stream associated with the first host, and receiving, through the second communication link, a second live streaming video stream associated with the second host;

the presenting the first bullet-screen comment information in the first area includes:

decoding the first live streaming video stream and the first bullet-screen comment information by using a first video player, to obtain a decoded first live streaming picture and a decoded first bullet-screen comment;

playing the first live streaming picture in the first area by using the first video player, and displaying the first bullet-screen comment in a floating manner on an upper layer of the first video player;

the presenting the second bullet-screen comment information in the second area includes:

decoding the second live streaming video stream and the second bullet-screen comment information by using a second video player, to obtain a decoded second live streaming picture and a decoded second bullet-screen comment; and

playing the second live streaming picture in the second area by using the second video player, and displaying the second bullet-screen comment in a floating manner on an upper layer of the second video player.

Optionally, the method further includes:

exiting the split screen mode in response to a co-hosting end instruction for the first host and the second host;

decoding the first live streaming video stream and the first bullet-screen comment information by using the first video player, to obtain a decoded third live streaming picture and a decoded third bullet-screen comment; and

playing the third live streaming picture on the screen in full screen by using the first video player, and displaying the third bullet-screen comment in a floating manner on the upper layer of the first video player.

Optionally, the method further includes:

establishing the first communication link with a server when it is detected that a user enters a playback page of a live streaming room;

receiving, through the first communication link, the first live streaming video stream and the first bullet-screen comment information associated with the first host that are sent by the server;

decoding the first live streaming video stream and the first bullet-screen comment information by using the first video player, to obtain a decoded fourth live streaming picture and a decoded fourth bullet-screen comment; and

playing the fourth live streaming picture on the screen in full screen by using the first video player, and displaying the fourth bullet-screen comment in a floating manner on the upper layer of the first video player.

Optionally, both the first communication link and the second communication link are socket long links.

This application further provides a bullet-screen comment sending method in co-hosting during live streaming, applied to a server, including:

receiving a co-hosting instruction initiated by a first host by using a first host terminal, where the co-hosting instruction is used to implement co-hosting between the first host and a second host in a live streaming room;

sending the co-hosting instruction to a second host terminal corresponding to the second host;

receiving co-hosting status information fed back by the second host by using the second host terminal;

when the co-hosting status information is a co-hosting success instruction, establishing a first communication link with a terminal device; and

sending, to the terminal device through a second communication link pre-established with the terminal device, first bullet-screen comment information associated with the first host, and sending, to the terminal device through the first communication link established with the terminal device, second bullet-screen comment information associated with the second host.

Optionally, the method further includes:

receiving a co-hosting end instruction sent by the first host by using the first host terminal, or receiving a co-hosting end instruction sent by the second host by using the second host terminal; and

disconnecting the first communication link established with the terminal device.

This application further provides a bullet-screen comment presentation apparatus in co-hosting during live streaming, including:

a response module, configured to enable a split screen mode in response to a co-hosting success instruction for a first host and a second host, where the split screen mode means displaying a first area and a second area on a screen, the first area is associated with the first host, and the second area is associated with the second host;

a receiving module, configured to receive first bullet-screen comment information associated with the first host, and receive second bullet-screen comment information associated with the second host; and

a presentation module, configured to present the first bullet-screen comment information in the first area, and present the second bullet-screen comment information in the second area.

This application further provides a bullet-screen comment sending apparatus in co-hosting during live streaming, including:

a first receiving module, configured to receive a co-hosting instruction initiated by a first host by using a first host terminal, where the co-hosting instruction is used to implement co-hosting between the first host and a second host in a live streaming room;

a first sending module, configured to send the co-hosting instruction to a second host terminal corresponding to the second host;

a second receiving module, configured to receive co-hosting status information fed back by the second host by using the second host terminal;

an establishing module, configured to: when the co-hosting status information is a co-hosting success instruction, establish a first communication link with a terminal device; and

a second sending module, configured to send, to the terminal device through a second communication link pre-established with the terminal device, first bullet-screen comment information associated with the first host, and send, to the terminal device through the first communication link established with the terminal device, second bullet-screen comment information associated with the second host.

This application further provides a computer device, where the computer device includes a memory, a processor, and a computer program stored in the memory and capable of running on the processor, and the processor implements the steps of the foregoing methods when executing the computer program.

This application further provides a computer-readable storage medium. A computer program is stored on the computer-readable storage medium. When the computer program is executed by a processor, the steps of the foregoing methods are implemented.

In this embodiment, after the first host and the second host are in co-hosting, the terminal device receives the first bullet-screen comment information associated with the first host that is sent by the server, and receives the second bullet-screen comment information associated with the second host that is sent by the server. Then, after obtaining the bullet-screen comment information associated with the two hosts, the terminal device presents the first bullet-screen comment information in the first area of the screen, and presents the second bullet-screen comment information in the second area of the screen. Therefore, the bullet-screen comments of the first host A and the second host B are simultaneously displayed on the screen in the split screen mode, and audiences of the two hosts can interact with each other. This improves interaction between the audiences and enhances user experience.

### BRIEF DESCRIPTION OF DRAWINGS

FIG. 1 is a schematic diagram of an environment of bullet-screen comment presentation and sending methods in co-hosting during live streaming according to embodiments of this application;

FIG. 2 is a flowchart of an embodiment of a bullet-screen comment presentation method in co-hosting during live streaming according to this application;

FIG. 3 is a schematic flowchart of detailed steps for presenting first bullet-screen comment information in a first area according to an implementation of this application;

FIG. 4 is a schematic flowchart of detailed steps for presenting second bullet-screen comment information in a second area according to an implementation of this application;

FIG. 5 is a flowchart of another embodiment of a bullet-screen comment presentation method in co-hosting during live streaming according to this application;

FIG. 6 is a flowchart of still another embodiment of a bullet-screen comment presentation method in co-hosting during live streaming according to this application;

FIG. 7 is a flowchart of an embodiment of a bullet-screen comment sending method in co-hosting during live streaming according to this application;

FIG. 8 is a flowchart of another embodiment of a bullet-screen comment sending method in co-hosting during live streaming according to this application;

FIG. 9 is a program module diagram of an embodiment of a bullet-screen comment presentation apparatus in co-hosting during live streaming according to this application;

FIG. 10 is a program module diagram of an embodiment of a bullet-screen comment sending apparatus in co-hosting during live streaming according to this application; and

FIG. 11 is a schematic diagram of a hardware structure of a computer device that performs the bullet-screen comment presentation and sending methods in co-hosting during live streaming according to an embodiment of this application.

### DESCRIPTION OF EMBODIMENTS

The following further describes the advantages of this application with reference to the accompanying drawings and specific embodiments.

The exemplary embodiments will be described in detail here and the embodiments are shown in the accompanying drawings. When the following description involves in the accompanying drawings, unless otherwise specified, a same numeral in different accompanying drawings represents a same or similar element. The implementations described in the following exemplary embodiments do not represent all implementations consistent with this disclosure. On the contrary, they are only embodiments of an apparatus and a method detailed in the appended claims and consistent with some aspects of this disclosure.

The terms used in this disclosure are merely used to describe specific embodiments, but are not intended to limit this disclosure. The singular forms “one”, “the”, and “this” used in this disclosure and the appended claims are also intended to cover plural forms, unless otherwise specified in the context clearly. It should be further understood that the term “and/or” used in this specification indicates and includes any or all possible combinations of one or more associated listed items.

It should be understood that, although terms first, second, third, or the like may be used in this disclosure to describe various information, which shall not be limited to these terms. These terms are only used to differentiate between information of the same type. For example, without departing from the scope of this disclosure, first information may also be referred to as second information. Similarly, the second information may also be referred to as the first information. Depending on the context, for example, the word “if” used herein can be explained as “while”, “when”, or “in response to determining”.

In the description of this application, it should be understood that digit numbers before steps does not indicate a sequence of performing the steps, and are only used to facilitate description of this application and differentiation of each step, but are not to be construed as a limitation to this application.

When performing live streaming in a live streaming room, a host often performs co-hosting interaction with another host. For example, during live streaming, a host A may perform co-hosting interaction with a host B. However, the inventor finds that when the host A performs co-hosting interaction with the host B, a user who watches a live streaming video of the host A in a live streaming room can only interact with another user in the live streaming room by using a bullet-screen comment. A user who watches a live streaming video of the host B in another live streaming room can only interact with another user in the live streaming room by using a bullet-screen comment. That is, although the two hosts perform co-hosting interaction with each other, their respective live streaming users cannot directly interact with each other. This results in insufficient interaction between the users and poor user experience.

This disclosure provides techniques for presenting and transmitting bullet screens during co-hosted live streaming. A bullet screen may be generated based on comments/information sent from a user. A bullet screen may be displayed in an overlay above a video. For example, a bullet screen (i.e., bullet-screen comment) may be shown moving across video frames, such as floating/scrolling (e.g., from right to left, left to right, top to bottom, bottom to top) across one or more video frames. Bullet screen data comprise comments on content (e.g., live streaming videos).

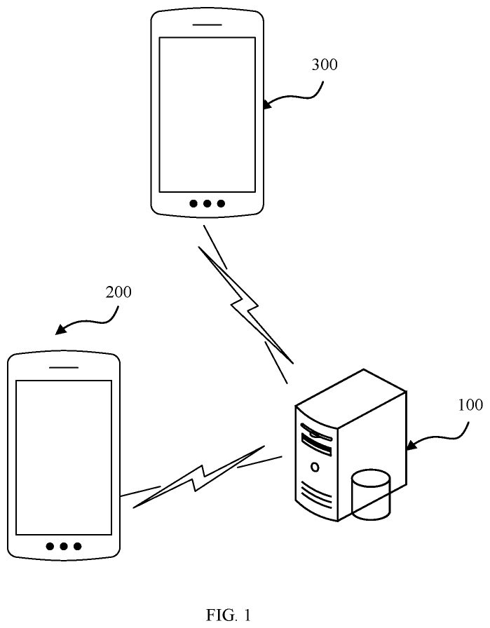

FIG. 1 is a schematic diagram of an application scenario according to an embodiment of this application. The application scenario includes a live streaming server computing system (i.e., server) 100, a host terminal computing device (i.e., host terminal) 200, and an audience terminal computing device (i.e., audience terminal) 300. The live streaming server 100, the host terminal 200, and the audience terminal 300 are located in a wireless network or a wired network. The live streaming server 100 may exchange data with the host terminal 200 and the audience terminal 300. In some implementations, a quantity of host terminals 200 (only one shown in FIG. 1) and a quantity of audience terminals 300 (only one shown in FIG. 1) may not be limited. The audience terminal 300 and the host terminal 200 may use the live streaming server 100 as a transmission medium, and implement mutual data exchange through the Internet.

In this embodiment of this application, the live streaming server 100 may be a separate server, a server cluster, a local server, or a cloud server. A specific type of the server may not be limited in this embodiment of this application. The host terminal 200 and the audience terminal 300 each may be a mobile phone, a smartphone, a notebook computer, a desktop computer, a tablet computer, a personal digital assistant (PDA), a media player, a smart television, a wearable electronic device, or the like. A specific type of the terminal device may not be limited in this embodiment of this application.

In this embodiment, a live streaming client may be installed in the host terminal 200, and the live streaming client is used by a host to implement video live streaming. The live streaming client may be a computer application (APP) installed in the host terminal 200, or may be a web client. The web client may be an application developed based on a web architecture.

In this embodiment, an audience client may be installed in the audience terminal computing device (i.e., audience terminal) 300, and the audience client is used by an audience to receive live streaming content, and present the live streaming content. The audience client may be a computer application (APP) installed in the audience terminal 300, or may be a web client. The web client may be an application developed based on the web architecture.

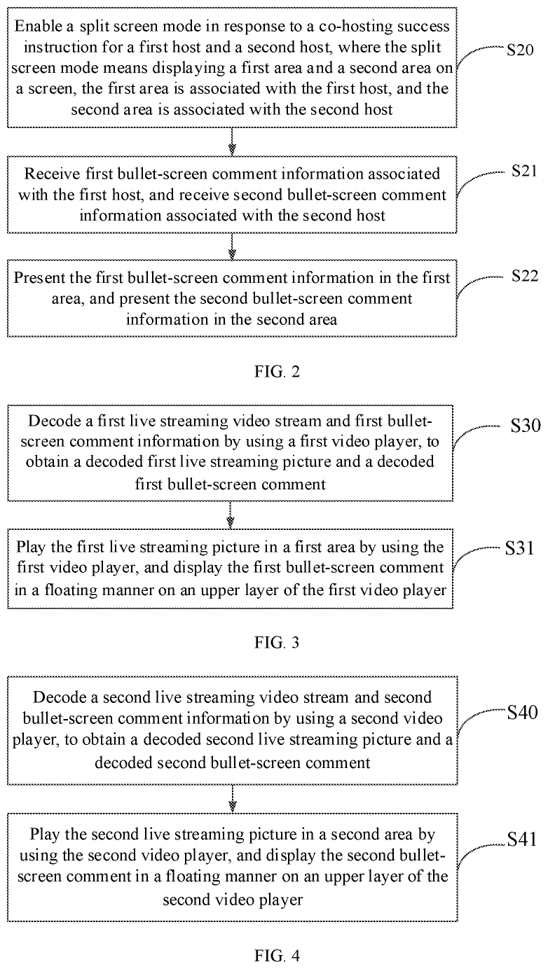

FIG. 2 is a schematic flowchart of presenting bullet screens (i.e., bullet-screen comments) during co-hosted live streaming according to an embodiment of this application. The method is applied to a terminal computing device (i.e., terminal device), the terminal device may be an audience terminal, or may be a host terminal. It may be understood that the flowchart in this method embodiment is not used to limit a sequence for performing steps. It can be learned from the figure that, the bullet-screen comment presentation method in co-hosting during live streaming provided in this embodiment includes:

Step S20: Enable a split screen mode in response to a co-hosting success instruction for a first host and a second host, where the split screen mode means displaying a first area and a second area on a screen, the first area is associated with the first host, and the second area is associated with the second host.

Specifically, the co-hosting success instruction is an instruction used to indicate that the first host and the second host are in co-hosting successfully.

The first area and the second area form a display area of the screen. Sizes of the first area and the second area may be the same or different. The sizes of the first area and the second area may be adjusted by a user in a specific display process.

In this embodiment, the split screen mode may be a horizontal split screen mode, or may be a vertical split screen mode, which is not limited in this embodiment.

In an example, when performing live streaming in a live streaming room, a first host A may perform co-hosting interaction with a host performing live streaming in another live streaming room. For example, the first host A may initiate a co-hosting request to a second host B, so that the first host A may perform co-hosting PK with the second host B. When the first host A triggers, by using a first host terminal, the co-hosting request for co-hosting with the second host, the first host terminal generates a co-hosting instruction based on the co-hosting request triggered by the first host A, and sends the co-hosting instruction to a server through a communication link established between the first host terminal and the server. The co-hosting instruction includes information about a second host terminal to be in co-hosting. After receiving the co-hosting instruction, the server sends the co-hosting instruction to the second host terminal, so that the second host B corresponding to the second host terminal can determine whether to receive the co-hosting request of the first host. The second host terminal may generate co-hosting status information based on a decision of the second host B, and sends the co-hosting status information to the server. The co-hosting status information may be co-hosting acceptance, or may be co-hosting rejection. When receiving the co-hosting status information of the second host terminal, the server may perform determining on the co-hosting status information, to determine whether the co-hosting status information is co-hosting acceptance or co-hosting rejection. When the server determines that the co-hosting status information is co-hosting acceptance, the server may send a co-hosting success instruction to audience terminals corresponding to all audiences currently in the live streaming room of the first host A, the first host terminal, and the second host terminal. In this way, each audience in the live streaming room of the first host A can receive the co-hosting success instruction by using a respective audience terminal. Similarly, each audience in the live streaming room of the second host B can receive the co-hosting success instruction by using a respective audience terminal. The first host A and the second host B can also receive the co-hosting success instruction by using respective host terminals. After receiving the co-hosting success instruction, each terminal device (including the host terminal and the audience terminal) may respond to the co-hosting success instruction, so as to enable a split screen mode.

In an implementation, when sending the co-hosting success instruction to terminal devices, the server may send the co-hosting success instruction to all the terminal devices in a broadcast manner. In another implementation, when sending the co-hosting success instruction to terminal devices, the server may alternatively send the co-hosting success instruction to all the terminal devices in a message subscription manner. Specifically, after obtaining the co-hosting success instruction, the server may send the co-hosting success instruction to message middleware. Each terminal device obtains the co-hosting success instruction by subscribing to a co-hosting success instruction message in the message middleware.

In an exemplary implementation, when receiving the co-hosting success instruction, the terminal device may receive, through a third communication link, the co-hosting success instruction sent by the server.

Specifically, each terminal device may pre-establish the third communication link with the server. The third communication link is used to specifically monitor whether there is the co-hosting success instruction in the server. After monitoring that there is a co-hosting success instruction in the server, the third communication link may be used to receive the co-hosting success instruction sent by the server.

The third communication link may be a socket long link. The socket long link is to maintain a socket connection between a client and a server for a long time without disconnecting. The third communication link may alternatively be a Web Socket long link.

Step S21: Receive first bullet-screen comment information associated with the first host, and receive second bullet-screen comment information associated with the second host.

Specifically, after the first host A and the second host B are in co-hosting successfully, the server sends the first bullet-screen comment information associated with the first host and the second bullet-screen comment information associated with the second host to the terminal device, so that the terminal device can receive the first bullet-screen comment information and the second bullet-screen comment information.

In an exemplary implementation, that receive first bullet-screen comment information associated with the first host, and receive second bullet-screen comment information associated with the second host includes:

receiving, through a first communication link, the first bullet-screen comment information associated with the first host, and receiving, through a second communication link, the second bullet-screen comment information associated with the second host.

Specifically, the first communication link is a channel established between the terminal device and the server for transmitting a first live streaming video stream and/or the first bullet-screen comment information associated with the first host A. The second communication link is a channel established between the terminal device and the server for transmitting a second live streaming video stream and/or the second bullet-screen comment information associated with the second host B.

In this embodiment, the first bullet-screen comment information and the second bullet-screen comment information each may include a common bullet-screen comment (comment information) sent by the audience in the live streaming room, and a reward gift (reward gift) common sent by the audience in the live streaming room.

The first communication link and the second communication link each may be a socket long link, a Web Socket long link, or the like.

When the server sends the first bullet-screen comment information and the second bullet-screen comment information to the terminal device, to facilitate the terminal device to distinguish between the first bullet-screen comment information and the second bullet-screen comment information, the server may send the first bullet-screen comment information through the first communication link established with the terminal device, and send the second bullet-screen comment information through the second communication link established with the terminal device.

It may be understood that the server may alternatively send the first bullet-screen comment information and the second bullet-screen comment information to the terminal device through only one communication link.

In an exemplary implementation, when sending the first bullet-screen comment information to the terminal device through the first communication link, the server may also send, to the terminal device through the first communication link, the first live streaming video stream associated with the first host, so that the terminal device can receive, through the first communication link, the first live streaming video stream associated with the first host. Similarly, when sending the second bullet-screen comment information to the terminal device through the second communication link, the server may also send, to the terminal device through the second communication link, the second live streaming video stream associated with the second host, so that the terminal device can receive, through the second communication link, the second live streaming video stream associated with the second host.

Step S22: Present the first bullet-screen comment information in the first area, and present the second bullet-screen comment information in the second area.

Specifically, after obtaining the first bullet-screen comment information and the second bullet-screen comment information, the terminal device may present the first bullet-screen comment information in the first area of the screen, and present the second bullet-screen comment information in the second area of the screen.

In an exemplary implementation, when the terminal device further receives the first live streaming video stream through the first communication link, with reference to FIG. 3, that present the first bullet-screen comment information in the first area includes: Step S30: Decode the first live streaming video stream and the first bullet-screen comment information by using a first video player, to obtain a decoded first live streaming picture and a decoded first bullet-screen comment. Step S31: Play the first live streaming picture in the first area by using the first video player, and display the first bullet-screen comment in a floating manner on an upper layer of the first video player.

Specifically, the first video player is a video player that decodes and plays a live streaming video stream and bullet-screen comment information in the current live streaming room before the split screen mode is enabled.

In this embodiment, for the first bullet-screen comment displayed in a floating manner on the first player, the user may control displaying of the first bullet-screen comment by using a preset bullet-screen comment on/off button. For example, if the user turns off a bullet-screen comment play button by using the button, the first bullet-screen comment is not displayed during playing of the first live streaming picture. Only when the bullet-screen comment play button is in an on state, the first bullet-screen comment is displayed during playing of the first live streaming picture.

In another implementation, instead of displaying the first bullet-screen comment in a floating manner, when the bullet-screen comment is displayed, a part of the first area is used to play the first live streaming picture, and the first bullet-screen comment is displayed in the remaining part of the first area.

In an exemplary implementation, when the terminal device further receives the second live streaming video stream through the second communication link, with reference to FIG. 4, that present the second bullet-screen comment information in the second area includes: Step S40: Decode the second live streaming video stream and the second bullet-screen comment information by using a second video player, to obtain a decoded second live streaming picture and a decoded second bullet-screen comment. Step S41: Play the second live streaming picture in the second area by using the second video player, and display the second bullet-screen comment in a floating manner on an upper layer of the second video player.

Specifically, the second video player is a video player that is newly created after the split screen mode is enabled and that is configured to decode and play the live streaming video stream and the bullet-screen comment information of the second host B.

In this embodiment, for the second bullet-screen comment displayed in a floating manner on the second player, the user may control displaying of the second bullet-screen comment by using a preset bullet-screen comment on/off button. For example, if the user turns off a bullet-screen comment play button by using the button, the second bullet-screen comment is not displayed during playing of the second live streaming picture. Only when the bullet-screen comment play button is in an on state, the second bullet-screen comment is displayed during playing of the second live streaming picture.

In another implementation, instead of displaying the second bullet-screen comment in a floating manner, when the bullet-screen comment is displayed, a part of the second area is used to play the second live streaming picture, and the second bullet-screen comment is displayed in the remaining part of the second area.

In this embodiment, after the first host and the second host are in co-hosting, the terminal device receives the first bullet-screen comment information associated with the first host that is sent by the server, and receives the second bullet-screen comment information associated with the second host that is sent by the server. Then, after obtaining the bullet-screen comment information associated with the two hosts, the terminal device presents the first bullet-screen comment information in the first area of the screen, and presents the second bullet-screen comment information in the second area of the screen. Therefore, the bullet-screen comments of the first host A and the second host B are simultaneously displayed on the screen in the split screen mode, and the audiences of the two hosts can interact with each other. This improves interaction between the audiences and enhances user experience.

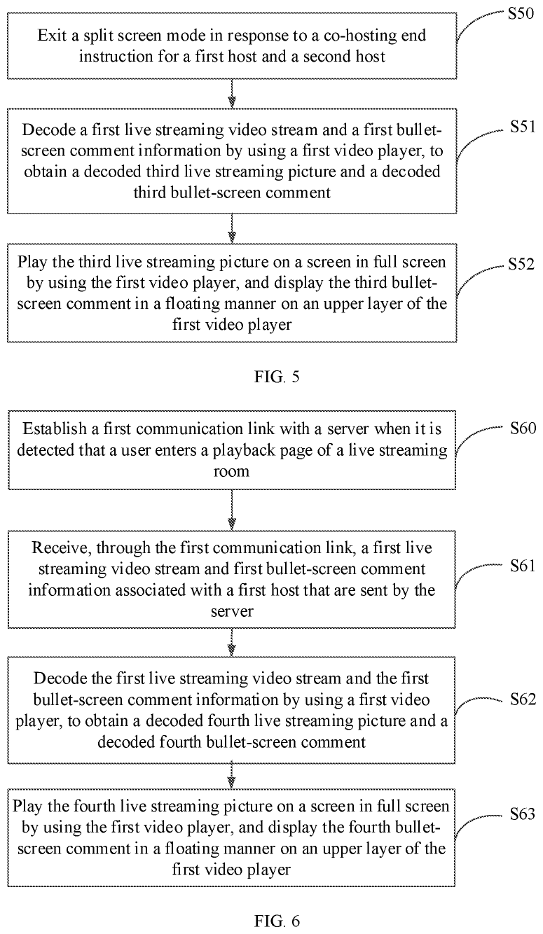

In an exemplary implementation, with reference to FIG. 5, the method further includes:

Step S50: Exit the split screen mode in response to a co-hosting end instruction for the first host and the second host.

Specifically, the co-hosting end instruction is used to represent an instruction for ending a co-hosting operation between the first host A and the second host B in the live streaming rooms.

In this embodiment, when the first host A and the second host B want to end co-hosting, for example, co-hosting PK between the first host A and the second host B ends, a co-hosting end request may be triggered by the first host A or the second host B by using the host terminal (the first host terminal or the second host terminal). In this case, the host terminal generates co-hosting status information based on the co-hosting end request triggered by the first host A or the second host B, and sends the co-hosting status information to the server. After receiving the co-hosting status information, the server performs determining on the co-hosting status information, to determine whether the co-hosting status information is a co-hosting end instruction. After determining that the co-hosting status information is a co-hosting end instruction, the server sends the co-hosting end instruction to each audience terminal through a communication link established with each audience terminal corresponding to the first host A and the second host B. In addition, the server may further send the co-hosting end instruction to the host terminals corresponding to the first host A and the second host B. In this way, each terminal device can receive the co-hosting end instruction sent by the server.

It should be noted that, a manner in which the server sends the co-hosting end instruction is the same as a manner in which the server sends the co-hosting success instruction, and details are not described in this embodiment.

After receiving the co-hosting end instruction sent by the server, the terminal device responds to the co-hosting end instruction, so as to exit the current split screen mode to return to a full screen mode.

Step S51: Decode the first live streaming video stream and the first bullet-screen comment information by using the first video player, to obtain a decoded third live streaming picture and a decoded third bullet-screen comment.

Specifically, after the split screen mode is exited, the first live streaming video stream and the first bullet-screen comment information are continuously decoded by using the first video player, to obtain the decoded third live streaming picture and the decoded third bullet-screen comment.

Step S52: Play the third live streaming picture on the screen in full screen by using the first video player, and display the third bullet-screen comment in a floating manner on the upper layer of the first video player.

Specifically, after the split screen mode is exited, the first video player plays the third live streaming picture on the screen in full screen, and displays the third bullet-screen comment only in a floating manner on the upper layer of the first video player, without displaying the bullet-screen comment associated with the second host B.

In an exemplary implementation, with reference to FIG. 6, the method further includes:

Step S60: Establish the first communication link with the server when it is detected that a user enters a playback page of the live streaming room.

Step S61: Receive, through the first communication link, the first live streaming video stream and the first bullet-screen comment information associated with the first host that are sent by the server.

Specifically, when detecting that the user enters the playback page of the live streaming room to watch a live streaming video of the first host A, the terminal device establishes the first communication link with the server, so that the terminal device can receive, from the server through the first communication link, the first live streaming video stream and the first bullet-screen comment information associated with the first host A.

Step S62: Decode the first live streaming video stream and the first bullet-screen comment information by using the first video player, to obtain a decoded fourth live streaming picture and a decoded fourth bullet-screen comment.

Specifically, when the user enters the live streaming room to watch the live streaming video of the first host A, the first video player decodes the first live streaming video stream and the first bullet-screen comment information, to obtain the decoded fourth live streaming picture and the decoded fourth bullet-screen comment.

Step S63: Play the fourth live streaming picture on the screen in full screen by using the first video player, and display the fourth bullet-screen comment in a floating manner on the upper layer of the first video player.

Specifically, when the user enters the live streaming room to watch the live streaming video of the first host A, the first video player plays the fourth live streaming picture in full screen, and displays the fourth bullet-screen comment in a floating manner on the upper layer of the first video player.

In another implementation, the first video player may play the fourth live streaming picture in some areas on the screen, and display the fourth bullet-screen comment in the remaining area on the screen.

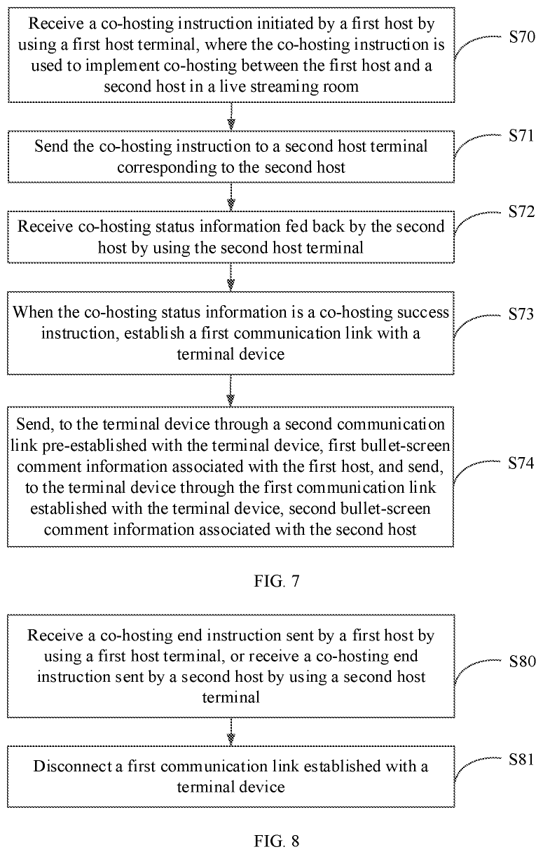

FIG. 7 is a schematic flowchart of a bullet-screen comment sending method in co-hosting during live streaming according to an embodiment of this application. This method is applied to a live streaming server 100. It may be understood that the flowchart in this method embodiment is not used to limit a sequence for performing steps. It can be learned from the figure that, the bullet-screen comment sending method in co-hosting during live streaming provided in this embodiment includes:

Step S70: Receive a co-hosting instruction initiated by a first host by using a first host terminal, where the co-hosting instruction is used to implement co-hosting between the first host and a second host in a live streaming room.

Step S71: Send the co-hosting instruction to a second host terminal corresponding to the second host.

Step S72: Receive co-hosting status information fed back by the second host by using the second host terminal.

Step S73: When the co-hosting status information is a co-hosting success instruction, establish a first communication link with the terminal device.

Step S74: Send, to the terminal device through a second communication link pre-established with the terminal device, first bullet-screen comment information associated with the first host, and send, to the terminal device through the first communication link established with the terminal device, second bullet-screen comment information associated with the second host.

Specifically, when performing live streaming in a live streaming room, a first host A may perform co-hosting interaction with a host performing live streaming in another live streaming room. For example, the first host A may initiate a co-hosting request to a second host B, so that the first host A may perform co-hosting PK with the second host B.

In this embodiment, when the first host A triggers, by using the first host terminal, the co-hosting request for co-hosting with the second host, the first host terminal generates a co-hosting instruction based on the co-hosting request triggered by the first host A, and sends the co-hosting instruction to the server through a communication link established between the first host terminal and the server. The co-hosting instruction includes information about the second host terminal to be in co-hosting.

After receiving the co-hosting instruction, the server sends the co-hosting instruction to the second host terminal, so that the second host B corresponding to the second host terminal can determine whether to receive the co-hosting request of the first host. The second host terminal may generate the co-hosting status information based on a decision of the second host B, and sends the co-hosting status information to the server. The co-hosting status information may be co-hosting acceptance, or may be co-hosting rejection. When receiving the co-hosting status information of the second host terminal, the server may perform determining on the co-hosting status information, to determine whether the co-hosting status information is the co-hosting acceptance or the co-hosting rejection. When the server determines that the co-hosting status information is the co-hosting acceptance, the server may send the co-hosting success instruction to audience terminals corresponding to all audiences currently in the live streaming room of the first host A, the first host terminal, and the second host terminal. In this way, each audience in the live streaming room of the first host A can receive the co-hosting success instruction by using a respective audience terminal. Similarly, each audience in a live streaming room of the second host B can receive the co-hosting success instruction by using a respective audience terminal. The first host A and the second host B can also receive the co-hosting success instruction by using respective host terminals.

In this embodiment, when determining that the co-hosting status information is a co-hosting success instruction, the server further establishes a new communication link with each terminal device, so that a live streaming video and/or bullet-screen comment information of a corresponding host (the first host A or the second host B) can be transmitted through the communication link.

It should be noted that, in this embodiment, the first communication link and the second communication link are respectively corresponding to the second communication link and the first communication link in the foregoing bullet-screen comment presentation method in co-hosting during live streaming.

In an exemplary implementation, with reference to FIG. 8, the method further includes: Step S80: Receive a co-hosting end instruction sent by the first host by using the first host terminal, or receive a co-hosting end instruction sent by the second host by using the second host terminal. Step S81: Disconnect the first communication link established with the terminal device.

Specifically, when co-hosting between the first host A and the second host B ends, the server disconnects the first communication link that is established with the terminal device and that is used to transmit a second live streaming video stream and the second bullet-screen comment information associated with the second host B, so that the terminal device can stop receiving the second live streaming video stream and/or the second bullet-screen comment information associated with the second host B, and restore a normal play mode.

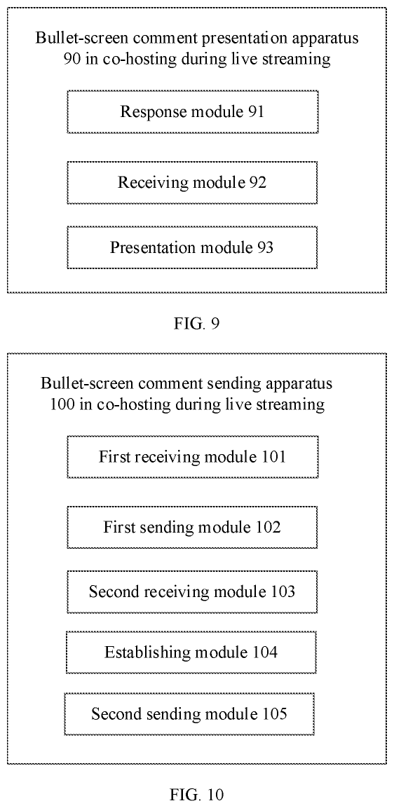

FIG. 9 is a program module diagram of an embodiment of a bullet-screen comment presentation apparatus 90 in co-hosting during live streaming according to this application.

In this embodiment, the bullet-screen comment presentation apparatus 90 in co-hosting during live streaming includes a series of computer program instructions stored in a memory. When the computer program instructions are executed by a processor, the bullet-screen comment presentation method in co-hosting during live streaming in the embodiments of this application can be implemented. In some embodiments, based on a specific operation implemented by each part of the computer program instructions, the bullet-screen comment presentation apparatus 90 in co-hosting during live streaming may be divided into one or more modules, which may be specifically divided into the following modules:

a response module 91, configured to enable a split screen mode in response to a co-hosting success instruction for a first host and a second host, where the split screen mode means displaying a first area and a second area on a screen, the first area is associated with the first host, and the second area is associated with the second host;

a receiving module 92, configured to receive first bullet-screen comment information associated with the first host, and receive second bullet-screen comment information associated with the second host; and

a presentation module 93, configured to present the first bullet-screen comment information in the first area, and present the second bullet-screen comment information in the second area.

In an exemplary implementation, the receiving module 92 is further configured to receive, through a first communication link, the first bullet-screen comment information associated with the first host, and receive, through a second communication link, the second bullet-screen comment information associated with the second host.

In an exemplary implementation, the receiving module 92 is further configured to receive, through the first communication link, a first live streaming video stream associated with the first host, and receive, through the second communication link, a second live streaming video stream associated with the second host.

The presentation module 93 is further configured to: decode the first live streaming video stream and the first bullet-screen comment information by using a first video player, to obtain a decoded first live streaming picture and a decoded first bullet-screen comment; and play the first live streaming picture in the first area by using the first video player, and display the first bullet-screen comment in a floating manner on an upper layer of the first video player.

The presentation module 93 is further configured to: decode the second live streaming video stream and the second bullet-screen comment information by using a second video player, to obtain a decoded second live streaming picture and a decoded second bullet-screen comment; and play the second live streaming picture in the second area by using the second video player, and display the second bullet-screen comment in a floating manner on an upper layer of the second video player.

In an exemplary implementation, the response module 91 is further configured to exit the split screen mode in response to a co-hosting end instruction for the first host and the second host.

The presentation module 93 is further configured to: decode the first live streaming video stream and the first bullet-screen comment information by using the first video player, to obtain a decoded third live streaming picture and a decoded third bullet-screen comment; and play the third live streaming picture on the screen in full screen by using the first video player, and display the third bullet-screen comment in a floating manner on the upper layer of the first video player.

In an exemplary implementation, the bullet-screen comment presentation apparatus 90 in co-hosting during live streaming further includes an establishing module and a receiving module.

The establishing module is configured to establish the first communication link with a server when it is detected that a user enters a playback page of a live streaming room.

The receiving module is configured to receive, through the first communication link, the first live streaming video stream and the first bullet-screen comment information associated with the first host that are sent by the server.

The presentation module 93 is further configured to: decode the first live streaming video stream and the first bullet-screen comment information by using the first video player, to obtain a decoded fourth live streaming picture and a decoded fourth bullet-screen comment; and play the fourth live streaming picture on the screen in full screen by using the first video player, and display the fourth bullet-screen comment in a floating manner on the upper layer of the first video player.

In an exemplary implementation, both the first communication link and the second communication link are socket long links.

In this embodiment, after the first host and the second host are in co-hosting, a terminal device receives the first bullet-screen comment information associated with the first host that is sent by the server, and receives the second bullet-screen comment information associated with the second host that is sent by the server. Then, after obtaining the bullet-screen comment information associated with the two hosts, the terminal device presents the first bullet-screen comment information in the first area of the screen, and presents the second bullet-screen comment information in the second area of the screen. Therefore, bullet-screen comments of a first host A and a second host B are simultaneously displayed on the screen in the split screen mode, and audiences of the two hosts can interact with each other. This improves interaction between the audiences and enhances user experience.

FIG. 10 is a program module diagram of an embodiment of a bullet-screen comment sending apparatus 100 in co-hosting during live streaming according to this application.

In this embodiment, the bullet-screen comment sending apparatus 100 in co-hosting during live streaming includes a series of computer program instructions stored in a memory. When the computer program instructions are executed by a processor, the bullet-screen comment sending method in co-hosting during live streaming in the embodiments of this application can be implemented. In some embodiments, based on a specific operation implemented by each part of the computer program instructions, the bullet-screen comment sending apparatus 100 in co-hosting during live streaming may be divided into one or more modules, which may be specifically divided into the following modules:

a first receiving module 101, configured to receive a co-hosting instruction initiated by a first host by using a first host terminal, where the co-hosting instruction is used to implement co-hosting between the first host and a second host in a live streaming room;

a first sending module 102, configured to send the co-hosting instruction to a second host terminal corresponding to the second host;

a second receiving module 103, configured to receive co-hosting status information fed back by the second host by using the second host terminal;

an establishing module 104, configured to: when the co-hosting status information is a co-hosting success instruction, establish a first communication link with a terminal device; and

a second sending module 105, configured to send, to the terminal device through a second communication link pre-established with the terminal device, first bullet-screen comment information associated with the first host, and send, to the terminal device through the first communication link established with the terminal device, second bullet-screen comment information associated with the second host.

In an exemplary implementation, the bullet-screen comment sending apparatus 100 in co-hosting during live streaming further includes a third receiving module and a disconnection module.

The third receiving module is configured to receive a co-hosting end instruction sent by the first host by using the first host terminal, or receive a co-hosting end instruction sent by the second host by using the second host terminal.

The disconnection module is configured to disconnect the first communication link established with the terminal device.

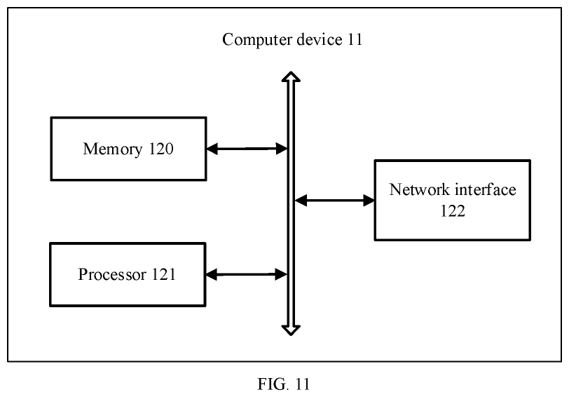

FIG. 11 is a schematic diagram of a hardware architecture of a computer device 11 applicable to the bullet-screen comment presentation and sending methods in co-hosting during live streaming according to an embodiment of this application. In this embodiment, the computer device 11 is a device that can automatically calculate a value and/or process information based on an instruction that is set or stored in advance. For example, the computer device 11 may be a tablet computer, a notebook computer, a desktop computer, a rack server, a blade server, a tower server, or a cabinet server (including an independent server, or a server cluster including a plurality of servers). As shown in FIG. 11, the computer device 11 at least includes but is not limited to: a memory 120, a processor 121, and a network interface 122 that can be communicatively connected to each other by using a system bus.

The memory 120 includes at least one type of computer-readable storage medium. The readable storage medium may be volatile or non-volatile. Specifically, the readable storage medium includes a flash memory, a hard disk, a multimedia card, a card-type storage (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, and the like. In some embodiments, the memory 120 may be an internal storage module of the computer device 11, such as a hard disk or a memory of the computer device 11. In some other embodiments, the memory 120 may be an external storage device of the computer device 11, for example, a removable hard disk, a smart media card (SMC), a secure digital (SD) card, or a flash card that is disposed on the computer device 11. Certainly, the memory 120 may include both an internal storage module of the computer device 11 and an external storage device of the computer device 11. In this embodiment, the memory 120 is usually configured to store an operating system and various application software that are installed on the computer device 11, for example, program code of the bullet-screen comment presentation and sending methods in co-hosting during live streaming. In addition, the memory 120 may be further configured to temporarily store various types of data that has been output or is to be output.

In some embodiments, the processor 121 may be a central processing unit (CPU), a controller, a microcontroller, a microprocessor, or another chip of the bullet-screen comment presentation or sending method in co-hosting during live streaming. The processor 121 is usually configured to control an overall operation of the computer device 11, for example, perform control and processing related to data exchange or communication performed by the computer device 11. In this embodiment, the processor 121 is configured to run program code stored in the memory 120 or process data.

The network interface 122 may include a wireless network interface or a wired network interface, and the network interface 122 is usually configured to establish a communication link between the computer device 11 and another computer device. For example, the network interface 122 is configured to: connect the computer device 11 to an external terminal by using a network, and establish a data transmission channel, a communication link, and the like between the computer device 11 and the external terminal. The network may be a wireless or wired network such as an Intranet, the Internet, a global system for mobile communications (GSM), a wideband code division multiple access (WCDMA), a 4G network, a 5G network, Bluetooth, or Wi-Fi.

It should be noted that FIG. 11 shows only a computer device with the components 120 to 122. However, it should be understood that implementation of all the shown components is not required, and more or fewer components may be alternatively implemented.

In this embodiment, the bullet-screen comment presentation and sending methods in co-hosting during live streaming stored in the memory 120 may be further divided into one or more program modules to be executed by one or more processors (the processor 121 in this embodiment), so as to complete this application.

An embodiment of this application provides a computer-readable storage medium. The computer-readable storage medium stores a computer program. When the computer program is executed by a processor, the steps of the bullet-screen comment presentation and sending methods in co-hosting during live streaming in the embodiments are implemented.

In this embodiment, the computer-readable storage medium includes a flash memory, a hard disk, a multimedia card, a card-type storage (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, and the like. In some embodiments, the computer-readable storage medium may be an internal storage unit of a computer device, such as a hard disk or a memory of the computer device. In some other embodiments, the computer-readable storage medium may be an external storage device of the computer device, for example, a removable hard disk, a smart media card (SMC), a secure digital (SD) card, or a flash card that is disposed on the computer device. Certainly, the computer-readable storage medium may include both an internal storage unit of the computer device and an external storage device of the computer device. In this embodiment, the computer-readable storage medium is usually configured to store an operating system and various application software that are installed on the computer device, for example, program code of the bullet-screen comment presentation and sending methods in co-hosting during live streaming in the embodiments. In addition, the computer-readable storage medium may be further configured to temporarily store various types of data that has been output or is to be output.

The apparatus embodiments described above are only schematic, and units described as separate components may or may not be physically separated. Components displayed as units may or may not be physical units, that is, the components may be located in one place, or may be distributed to at least two network units. Some or all of the modules may be selected based on actual needs to achieve the objective of the solution of the embodiments of this application. Those of ordinary skill in the art can understand and implement the embodiment without creative efforts.

Through the description of the foregoing implementations, those of ordinary skill in the art can clearly understand that the implementations can be implemented by using software plus a universal hardware platform, or certainly, can be implemented through hardware. Those of ordinary skill in the art can understand that all or some of processes for implementing the methods of the foregoing embodiments can be completed by instructing relevant hardware through a computer program. The program may be stored in a computer-readable storage medium. When the program is executed, processes of the embodiments of the foregoing methods may be included. The storage medium may be a magnetic disk, an optical disc, a read-only memory (ROM), a random access memory (RAM), or the like.

Finally, it should be noted that the foregoing embodiments are merely intended for describing the technical solutions of this application, but not for limiting this application. Although this application is described in detail with reference to the foregoing embodiments, those of ordinary skill in the art should understand that they may still make modifications to the technical solutions described in the foregoing embodiments or make equivalent replacements to some or all technical features thereof. These modifications or replacements do not make the essence of the corresponding technical solutions deviate from the scope of the technical solutions of the embodiments of this application.

What is claimed is:

1. A method of presenting bullet screens during co-hosted live streaming, applied to a terminal computing device, comprising:
monitoring whether there is a co-hosting success instruction, wherein the co-hosting success instruction is indicative of co-hosting by a first host and a second host in live streaming;
enabling a split screen mode in response to receiving the co-hosting success instruction, wherein the split screen mode is configured to implement simultaneous display of a first area and a second area on a screen, the first area is configured to display content associated with the first host, and the second area is configured to display content associated with the second host;
receiving first bullet screen data associated with the first host, and receiving second bullet screen data associated with the second host, wherein the first bullet screen data comprise comments on a first live streaming video associated with the first host, and the second bullet screen data comprise comments on a second live streaming video associated with the second host; and
presenting the comments on the first live streaming video in the first area, and presenting the comments on the second live streaming video in the second area.

2. The method according to claim 1, further comprising:
receiving, through a first communication link, the first live streaming video and the first bullet screen data associated with the first host; and
receiving, through a second communication link, the second live streaming video and the second bullet screen data associated with the second host, wherein the first communication link or the second communication link is a new communication link established in response to the co-hosting success instruction.

3. The method according to claim 1, further comprising:
decoding the first live streaming video and the first bullet screen data using a first video player to obtain decoded first live streaming pictures and decoded first bullet screens;
playing the first live streaming pictures in the first area by the first video player, and displaying the first bullet screens in a manner of floating across the first live streaming pictures on an upper layer of the first video player;
decoding the second live streaming video and the second bullet screen data using a second video player to obtain decoded second live streaming pictures and decoded second bullet screens; and
playing the second live streaming pictures in the second area using the second video player, and displaying the second bullet screens in a manner of floating across the second live streaming pictures on an upper layer of the second video player.

4. The method according to claim 1, further comprising:
exiting the split screen mode in response to receiving a co-hosting end instruction indicative of ending the co-hosting of the first host and the second host; and
decoding the first live streaming video and the first bullet screen data using the first video player to obtain decoded third live streaming pictures and decoded third bullet screens; and
playing the third live streaming pictures on the screen in full screen using the first video player, and displaying the third bullet screens in a manner of floating across the third live streaming pictures on the upper layer of the first video player.

5. The method according to claim 1, further comprising:
monitoring whether there is the co-hosting success instruction using a pre-established communication link; and
receiving the co-hosting success instruction via the pre-established communication link, wherein the pre-established communication link is dedicated to monitoring and transmitting co-hosting success instructions.

6. The method according to claim 2, wherein both the first communication link and the second communication link are socket long links.

7. A method of transmitting bullet screens during co-hosted live streaming, applied to a server computing device, comprising:
receiving a co-hosting request initiated by a first host terminal device associated with a first host, wherein the co-hosting request comprises a request for co-hosting with a second host in live streaming;
sending the co-hosting request to a second host terminal device associated with the second host;
receiving co-hosting status information fed back from the second host terminal device, wherein the co-hosting status information indicates whether the second host accepts the co-hosting request;
transmitting a co-hosting success instruction to the first host terminal device, the second host terminal device, audience terminal devices associated with the first host, and audience terminal devices associated with the second host in response to determining that the co-hosting status information indicates an acceptance of the co-hosting request by the second host;
establishing a new communication link with each terminal device in response to determining that the co-hosting status information indicates the acceptance of the co-hosting request by the second host; and
transmitting, to each terminal device through an existing communication link pre-established with each terminal device, first bullet screen data associated with the first host or second bullet screen data associated with the second host, and transmitting, to each terminal device through the new communication link, second bullet screen data associated with the second host or first bullet screen data associated with the first host for simultaneous display of the first bullet screen data and the second bullet screen data on a same screen of each terminal device.

8. The method according to claim 7, further comprising:
receiving a co-hosting end instruction sent from the first host terminal device or sent from the second host terminal device; and
disconnecting the new communication link established with each terminal device in response to receiving the co-hosting end instruction.

9. A computing device, comprising:
at least one processor; and
at least one memory communicatively coupled to the at least one processor and comprising computer-readable instructions that upon execution by the at least one processor cause the at least one processor to perform operations comprising:
monitoring whether there is a co-hosting success instruction, wherein the co-hosting success instruction is indicative of co-hosting by a first host and a second host in a live streaming room;
enabling a split screen mode in response to receiving the co-hosting success instruction, wherein the split screen mode is configured to implement simultaneous display of a first area and a second area on a screen, the first area is configured to display content associated with the first host, and the second area is configured to display content associated with the second host;
receiving first bullet screen data associated with the first host, and receiving second bullet screen data associated with the second host, wherein the first bullet screen data comprise comments on a first live streaming video associated with the first host, and the second bullet screen data comprise comments on a second live streaming video associated with the second host; and
presenting the comments on the first live streaming video in the first area of the screen, and presenting the comments on the second live streaming video in the second area of the screen.

10. The computing device according to claim 9, the operations further comprising:
receiving, through a first communication link, the first live streaming video and the first bullet screen data associated with the first host; and
receiving, through a second communication link, the second live streaming video and the second bullet screen data associated with the second host, wherein the first communication link or the second communication link is a new communication link established in response to the co-hosting success instruction.

11. The computing device according to claim 9, the operations further comprising:
decoding the first live streaming video and the first bullet screen data using a first video player to obtain decoded first live streaming pictures and decoded first bullet screens;
playing the first live streaming pictures in the first area by the first video player, and displaying the first bullet screens in a manner of floating across the first live streaming pictures on an upper layer of the first video player;
decoding the second live streaming video and the second bullet screen data using a second video player to obtain decoded second live streaming pictures and decoded second bullet screens; and
playing the second live streaming pictures in the second area using the second video player, and displaying the second bullet screens in a manner of floating across the second live streaming pictures on an upper layer of the second video player.

12. The computing device according to claim 9, the operations further comprising:
exiting the split screen mode in response to receiving a co-hosting end instruction of ending the co-hosting by the first host and the second host; and
decoding the first live streaming video and the first bullet screen data using the first video player, to obtain decoded third live streaming pictures and decoded third bullet screens; and
playing the third live streaming pictures on the screen in full screen using the first video player, and displaying the third bullet screens in a manner of floating across the third live streaming pictures on the upper layer of the first video player.

13. The computing device according to claim 9, the operations further comprising:
monitoring whether there is the co-hosting success instruction using a pre-established communication link; and
receiving the co-hosting success instruction via the pre-established communication link, wherein the pre-established communication link is dedicated to monitoring and transmitting co-hosting success instructions.

14. The computing device according to claim 10, wherein both the first communication link and the second communication link are socket long links.

15. A computing system, comprising:
at least one processor; and
at least one memory communicatively coupled to the at least one processor and comprising computer-readable instructions that upon execution by the at least one processor cause the at least one processor to perform operations comprising:
receiving a co-hosting request initiated by a first host terminal device associated with a first host, wherein the co-hosting request comprises a request for co-hosting with a second host in a live streaming room;
sending the co-hosting request to a second host terminal device associated with the second host;
receiving co-hosting status information fed back from the second host terminal device, wherein the co-hosting status information indicates whether the second host accepts the co-hosting request;
transmitting a co-hosting success instruction to the first host terminal device, the second host terminal device, audience terminal devices associated with the first host, and audience terminal devices associated with the second host in response to determining that the co-hosting status information indicates an acceptance of the co-hosting request by the second host;
establishing a new communication link with each terminal device in response to determining that the co-hosting status information indicates the acceptance of the co-hosting request by the second host; and
transmitting, to each terminal device through an existing communication link pre-established with each terminal device, first bullet screen data associated with the first host or second bullet screen data associated with the second host, and transmitting, to each terminal device through the new communication link, second bullet screen data associated with the second host or first bullet screen data associated with the first host for simultaneous display of the first bullet screen data and the second bullet screen data on a same screen of each terminal device.

16. The computing system according to claim 15, the operations further comprising:
receiving a co-hosting end instruction sent from the first host terminal device or sent from the second host terminal device; and
disconnecting the new communication link established with each terminal device in response to receiving the co-hosting end instruction.
